(19) United States
(12) Patent Application Publication
(10) Pub. No.: US 2013/0112913 A1
(43) Pub. Date: May 9, 2013

(54) BIO-SOLUBLE FIBER-BASED MIXTURES AND THEIR USE IN MATRICES FOR INFRARED EMISSION

(71) Applicant: Gerard J. Lucidi, Moorestown, NJ (US)

(72) Inventor: Gerard J. Lucidi, Moorestown, NJ (US)

(21) Appl. No.: 13/726,952

(22) Filed: Dec. 26, 2012

Related U.S. Application Data
(63) Continuation of application No. 12/671,331, filed on Jan. 29, 2010, now abandoned.
(60) Provisional application No. 60/953,335, filed on Aug. 1, 2007.

(51) Int. Cl. C09K 5/14

(52) U.S. Cl. 252/73; 252/71

(57) ABSTRACT

Bio-soluble fiber-based matrices for use in infrared heaters prepared from mixtures comprising (a) bio-soluble fibers, (b) a particulate material capable of infrared emissivity, and (c) a binder comprising colloidal silica, wherein said bio-soluble fibers are present in an amount of about 60% by weight said particulate material capable of infrared emissivity is present in an amount of about 19% by weight said colloidal silica is present in an amount of about 17% by weight, said starch is present in an amount of about 3% by weight, and further comprises about 1% by weight of a water repellant agent based on the total weight of the mixture.

### FIELD OF THE INVENTION

This invention relates to rigid, porous matrices based on bio-soluble fibers for use as infrared emitters in infrared heaters.

### BACKGROUND OF THE INVENTION

Infrared (“IR”) heaters find use in various industrial heat applications, such as drying applications in papermaking. Typical IR heaters comprise a porous refractory ceramic matrix fitted into a metallic housing. The matrix of a typical infrared unit uses ceramic fibers and organic binders to create a porous material that acts as an infrared emitter when heated above certain temperatures.

Bio-soluble fibers, such as Superwool® 607® HT, are deemed a more environmentally friendly alternative to conventional ceramic fibers. However, it has been observed that the relatively shorter length and smaller diameter of bio-soluble fibers has rendered materials prepared from such fibers inadequate for use as matrices in IR heaters, i.e., the resulting materials are either sufficiently porous but insufficiently rigid or sufficiently rigid but insufficiently porous. Thus, an object of the present invention is to develop a matrix for use in IR heaters based on bio-soluble fibers that possesses the proper balance of rigidity and porosity necessary for use in IR heater applications.

### EMBODIMENTS OF THE INVENTION

An embodiment of the present invention is an mixture comprising (a) bio-soluble fibers, (b) a particulate material capable of infrared emissivity, (c) a binder comprising colloidal silica.

Another embodiment of the present invention is the above mixture, wherein said mixture is aqueous.

Another embodiment of the present invention is the above mixture, wherein at least about ⅔ by weight of said binder is said colloidal silica, based on the total weight of said binder.

Another embodiment of the present invention is the above mixture, wherein said colloidal silica has an average particle size of about 70 nm and a surface area of about 70 m2/g.

Another embodiment of the present invention is the above mixture, wherein said colloidal silica is in the form of an aqueous dispersion having a specific gravity of about 1.39, a pH at 25° C. of about 9.0 to about 9.5, and a viscosity at 25° C. of about 15 cp.

Another embodiment of the present invention is the above mixture, wherein said bio-soluble fibers comprise silica magnesia, silicon dioxide, calcium oxide, magnesium oxide, man-made vitreous fibers, or mixtures thereof.

Another embodiment of the present invention is the above mixture, wherein said particulate material capable of infrared emissivity comprises silicon carbide, silicon, silicon nitride, silicon carbonitride, and mixtures thereof.

Another embodiment of the present invention is the above mixture, wherein said bio-soluble fibers are present in an amount of from about 54% to about 66% by weight, said particulate material capable of infrared emissivity is present in an amount of from about 16% to about 23% by weight, and said binder is present in an amount of from about 16% to about 23% by weight, based on the total weight of the mixture.

Another embodiment of the present invention is the above mixture, further comprising a water repellant or water-proofing agent, an opacifier, or mixtures thereof.

Another embodiment of the present invention is the above mixture, wherein said binder comprises an organic binder.

Another embodiment of the present invention is the above mixture, wherein said organic binder is starch.

Another embodiment of the present invention is the above mixture, wherein said bio-soluble fibers are present in an amount of about 60% by weight, said particulate material capable of infrared emissivity is present in an amount of about 19% by weight, said colloidal silica is present in an amount of about 17% by weight, said starch is present in an amount of about 3% by weight, and further comprises about 1% by weight of a water repellant agent, based on the total weight of the mixture.

Yet another embodiment of the present invention is a process for forming a bio-soluble fiber-based matrix comprising molding the above mixture to a desired shape.

Yet another embodiment of the present invention is a bio-soluble fiber-based matrix prepared by the above process.

Another embodiment of the present invention is the above bio-soluble fiber-based matrix, wherein said matrix comprises (1) bio-soluble fibers in an amount in the range of from about 60% to about 75% by weight, (2) particulate material capable of infrared emissivity in an amount in the range of from about 12.5% to about 20% by weight, and (3) binder comprising colloidal silica in an amount in the range of from about 12.5% to about 20% by weight, based on the total weight of the matrix.

Yet another embodiment of the present invention is an infrared heater comprising the above porous, bio-soluble fiber-based matrix.

### DESCRIPTION OF THE INVENTION

As used herein, the singular terms “a” and “the” are synonymous and used interchangeably with “one or more” and “at least one,” unless the language and/or context clearly indicates otherwise.

The above-stated object was achieved by the manufacture of rigid, porous, bio-soluble fiber-based matrices which comprise bio-soluble fibers, a particulate material capable of infrared emissivity, and a binder comprising colloidal silica. Preferably, the bio-soluble fiber-based matrices of the present invention comprise bio-soluble fibers in an amount in the range of from about 60% to about 75% by weight, a particulate material capable of infrared emissivity in an amount in the range of from about 12.5% to about 20% by weight, and a binder comprising colloidal silica in an amount in the range of from about 12.5% to about 20% by weight, based on the total weight of matrix.

The bio-soluble fiber-based matrices of the present invention are capable of attaining temperatures of about 1850° F. (1010° C.) or greater while maintaining the physical properties necessary, i.e., porous yet possessing sufficient rigidity, for their use in harsh, industrial process heat applications.

Besides being considered more environmentally friendly, the bio-soluble fiber-based matrices of the present invention retain the same desirable characteristics found in conventional matrices prepared from ceramic fiber and organic binders. These characteristics include high fuel efficiency (e.g., greater than 65% conversion to radiation efficiency), quick heat up (e.g., 5 seconds to about 1850° F. or greater), and quick cool down (e.g., from about 1850° F. or greater to the touch in one second), and the ability to modulate its power output from about 1100° F. to about 1850° F. or greater.

The rigid, porous, bio-soluble fiber-based matrices of the present invention are prepared from mixtures comprising bio-soluble fibers, a particulate material capable of infrared emissivity, and a binder comprising colloidal silica. Preferably, these mixtures are aqueous. The mixtures of the present invention preferably comprise bio-soluble fibers in an amount in the range of from about 54% to about 66% by weight, a particulate material capable of infrared emissivity in an amount in the range of from about 16% to about 23% by weight, and a binder comprising colloidal silica in an amount in the range of from about 16% to about 23% by weight, based on the total solids weight of the mixture. In another preferred embodiment, the mixtures of the present invention comprise bio-soluble fibers in an amount of about 60% by weight, a particulate material capable of infrared emissivity in an amount of about 20% by weight, and a binder comprising colloidal silica in an amount of about 20% by weight, based on the total solids weight of the mixture.

Bio-soluble fibers are easily dissolved in the bodily fluids of and are ultimately excreted from living organisms. Any type of bio-soluble fibers may be used to prepare the mixtures and matrices of the present invention. Preferably, such fibers comprise silica magnesia, silicon dioxide, calcium oxide, magnesium oxide, man-made vitreous (silicate) fibers, or any mixture thereof.

The bio-soluble fibers used in the mixtures and matrices of the present invention can comprise from about 70% to about 80% silicon dioxide and from about 20% to about 30% of a mixture of calcium oxide and magnesium oxide. These bio-soluble fibers can also comprise from 71% to about 80% silicon dioxide and from about 20% to 29% of a mixture of calcium oxide and magnesium oxide. These bio-soluble fibers can also comprise from 75% to about 80% silicon dioxide and from about 20% to 25% of a mixture of calcium oxide and magnesium oxide. These bio-soluble fibers can also have one or more of the following characteristics: (1) a classification temperature of 1300° C., (2) a specific gravity of 2.50 g/cm³, and specific heat capacity at 1090° C. of 1.22 kJ/kgK. An example of bio-soluble fibers useful for the mixtures and matrices of the present invention includes, but is not limited to, Superwool® 607® HT (Thermal Ceramics, Inc. of 2102 Old Savannah Rd., P.O. Box 923, Augusta, Ga. 30903 USA).

Any particulate materials capable of infrared emissivity may be used in the mixtures and matrices of the present invention. Examples of such materials include, but are not limited to, silicon carbide, silicon, silicon nitride, silicon carbonitride, and mixtures thereof. Silicon carbide is preferred.

The binders used in the mixtures and matrices of the present invention comprise colloidal silica. Any type of colloidal silica may be used. The colloidal silica may have an average particle size of about 70 nm and a surface area of about 70 m²/g. This colloidal silica may also be used in the form of an aqueous dispersion. These aqueous dispersions may have one of more of the following characteristics: a specific gravity of about 1.39, a pH at 25° C. of about 9.0 to about 9.5, and a viscosity at 25° C. of about 15 cp. An example of a colloidal silica useful for the mixtures and matrices of the present invention includes, but is not limited to, Megasol® S50 (WesBond Corporation of 1135 East 7^{th} Street, Wilmington, Del. 19801 USA). In one embodiment, at least about ⅔ by weight of the binder is colloidal silica, based on the total weight of the binder. In another embodiment, the binder may consist of colloidal silica.

The binder used in the mixtures and matrices of the present invention may also comprise organic binders. An example of such an organic binder includes, but is not limited to, starch. If organic binder is present, the weight ratio of colloidal silica to organic binder is about 2:1 or greater, based on the total weight of binder. The weight ratio of colloidal silica to organic binder can also be about 3:1 or greater, about 4:1 or greater, about 5:1 or greater, or about 6:1 or greater, based on the total weight of binder. A weight ratio of colloidal silica to organic binder of about 5.7:1, based on the total weight of binder, is preferred.

The aqueous mixtures of the present invention, as well as the matrices of the present invention, can also comprise one or more water repellants or water-proofing agents, opacifiers, or mixtures thereof. An example of such a water repellant includes, but is not limited to, 346 Emulsion (Dow Corning), which is a 60% active silicone emulsion of a trimethylsilyl terminated medium viscosity polydimethylsiloxane.

In one embodiment, the mixture of the present invention comprises bio-soluble fibers in an amount of about 60% by weight, particulate material capable of infrared emissivity in an amount of about 19% by weight, colloidal silica in an amount of about 17% by weight, starch in an amount of about 3% by weight, and a water repellant agent in an amount of about 1% by weight, based on the total solids weight of the aqueous mixture.

U.S. Patent Application Pub. No. 2002/0123018 discloses matrices prepared from blends of at least two different maximum temperature rated materials, wherein at least one of the materials is at least about 100° C. above the maximum radiant face operating temperature and at least one material is at or below the maximum radiant face operating temperature. The Example in U.S. Patent Application Pub. No. 2002/0123018 discloses the preparation of a matrix from approximately ⅓ by weight of fibers having a recommended use limit of 1000° C. and approximately ⅔ by weight of fibers having a recommended use limit of 1200° C. The matrices of the present invention optionally do not comprise such blends.

Formation of the bio-soluble fiber-based matrices of the present invention can be achieved by any conventional process known in the art. Preferably, an aqueous molding process is used. In this process, bio-soluble fibers are added to water, followed by the particulate material capable of infrared emissivity, binder, and any other additives, to form an aqueous slurry. This slurry is then mixed. Once mixing is completed, the resulting mixture is molded to a desired shape.

An ionic wetting agent can optionally be added to this mixture to prevent the formation of clumps of bio-soluble fibers forming. Such clumping may result in a non-uniform distribution of the particulate material capable of infrared emissivity in the matrix. These ionic wetting agents may be anionic or cationic wetting agents and have hydrophobic and hydrophilic groups in the molecule which bond one side to the ceramic fiber or particle, and the other side to the water molecule. Preferably, the ionic wetting agents comprise an anionic or cationic detergent. Non-exclusive examples of such detergents include Alconox™ and other commercial detergents, including several brands of dish washing liquids.

The bio-soluble fiber-based matrices of the present invention can be used in any IR heater known in the art. Examples of such IR heaters include, but are not limited to, those described in U.S. Pat. Nos. 6,561,793; 5,090,898; 5,046,944; 4,722,681, 4,654,000; 4,224,018; 5,024,596; 4,589,843; 5,464,346; 4,224,018; 4,604,054; 4,654,000; 4,500,283; 4,443,185; 4,474,552; 4,416,618; 4,447,205; 5,464,346; and 4,378,207, and in U.S. Patent App. Pub. No. 2002/0123018 A1, which are all incorporated herein by reference in their entireties for all useful purposes.

Preferably, the low range limit of gas/air mixture flow through the bio-soluble fiber-based matrices of the present invention is in the range of from about 2.0″ water column to about 2.4″ water column. Preferably, the high range limit of gas/air mixture flow through the porous, bio-soluble fiber-based matrices of the present invention is in the range of from about 3.2″ water column to about 3.8″ water column. These flow rates allow a surface temperature of about 1850° F. or greater to be achieved.

### EXAMPLE

A rigid, porous bio-soluble fiber-based matrix according to the present invention was prepared via an aqueous molding process from:

120 lbs. of bulk Superwool® 607® HT

37.5 lbs of silicon carbide

34 lbs. dry weight of Megasol® S50

6 lbs. of starch

2 lbs of 346 Emulsion

The resulting matrices comprised from about 60% to about 75% by weight of the bio-soluble fibers, from about 12.5% to about 20% by weight of silicon carbide, and from about 12.5% to about 20% by weight of binder (i.e., colloidal silica and starch). The air flow through these matrices was 2.0″ water column, The gas/air mixture flow through these matrices was 2.4″ water column. Combustion of the gas/air mixture at a flow rate of 2.4″ water column the matrix achieved a matrix surface temperature 1850° F.

1. An mixture comprising:
(a) bio-soluble fibers;
(b) a particulate material capable of infrared emissivity; and
(c) a binder comprising colloidal silica.

2. The mixture of claim 1, wherein said mixture is aqueous.

3. The mixture of claim 2, wherein at least about ⅔ by weight of said binder is said colloidal silica, based on the total weight of said binder.

4. The mixture of claim 3, wherein said colloidal silica has an average particle size of about 70 nm and a surface area of about 70 m²/g.

5. The mixture of claim 4, wherein said colloidal silica is in the form of an aqueous dispersion having a specific gravity of about 1.39, a pH at 25° C. of about 9.0 to about 9.5, and a viscosity at 25° C. of about 15 cp.

6. The mixture of claim 1, wherein said bio-soluble fibers comprise silica magnesia, silicon dioxide, calcium oxide, magnesium oxide, man-made vitreous fibers, or mixtures thereof.

7. The aqueous mixture of claim 1, wherein said particulate material capable of infrared emissivity comprises silicon carbide, silicon, silicon nitride, silicon carbonitride, and mixtures thereof.

8. The mixture of claim 1, wherein said bio-soluble fibers are present in an amount of from about 54% to about 66% by weight, said particulate material capable of infrared emissivity is present in an amount of from about 16% to about 23% by weight, and said binder is present in an amount of from about 16% to about 23% by weight, based on the total solids weight of the aqueous mixture.

9. The mixture of claim 1, further comprising a water repellant or water-proofing agent, an opacifier, or mixtures thereof.

10. The mixture of claim 5, wherein said binder comprises an organic binder.

11. The mixture of claim 10, wherein said organic binder is starch.

12. The mixture of claim 11, wherein said bio-soluble fibers are present in an amount of about 60% by weight, said particulate material capable of infrared emissivity is present in an amount of about 19% by weight, said colloidal silica is present in an amount of about 17% by weight, said starch is present in an amount of about 3% by weight, and further comprises about 1% by weight of a water repellant agent, based on the total solids weight of the aqueous mixture.

13. A process for forming a bio-soluble fiber-based matrix comprising molding the mixture of claim 1 to a desired shape.

14. A bio-soluble fiber-based matrix prepared by the process of claim 13.

15. The bio-soluble fiber-based matrix of claim 14, wherein said matrix comprises (1) bio-soluble fibers in an amount in the range of from about 60% to about 75% by weight, (2) particulate material capable of infrared emissivity in an amount in the range of from about 12.5% to about 20% by weight, and (3) binder comprising colloidal silica in an amount in the range of from about 12.5% to about 20% by weight, based on the total weight of the matrix.

16. An infrared heating unit comprising the bio-soluble fiber-based matrix of claim 15.

17. A process for forming a bio-soluble fiber-based matrix comprising molding the mixture of claim 12 to a desired shape.

18. A bio-soluble fiber-based matrix prepared by the process of claim 17.

19. The bio-soluble fiber-based matrix of claim 18, wherein said matrix comprises (1) bio-soluble fibers in an amount in the range of from about 60% to about 75% by weight, (2) particulate material capable of infrared emissivity in an amount in the range of from about 12.5% to about 20% by weight, and (3) binder comprising colloidal silica in an amount in the range of from about 12.5% to about 20% by weight, based on the total weight of the matrix.

20. An infrared heating unit comprising the bio-soluble fiber-based matrix of claim 19.
